(19) United States
(12) Patent Application Publication
(10) Pub. No.: US 2002/0017318 A1
(43) Pub. Date: Feb. 14, 2002

(54) Print coating supply system for plurality of coating substances

(75) Inventor: John Kelley, Euless, TX (US)

Correspondence Address: JENKENS & GILCHRIST, PC, 1445 ROSS AVENUE, SUITE 3200, DALLAS, TX, 75202, US

(73) Assignee: ROYSE MANUFACTURING CO.

(21) Appl. No.: 09/920,168

(22) Filed: Aug. 1, 2001

Related U.S. Application Data
(60) Provisional application No. 60/222,704, filed on Aug. 2, 2000.

(51) Int. Cl. G05B 1/00

(52) U.S. Cl. 137/38

(57) ABSTRACT

A printing supply system for a plurality of coating substances. The system includes a first supply line for supplying a first fluid and a second supply line for supplying a second fluid. A first valve member is connected to the first supply line and to the second supply line for guiding flow therethrough. A supply tube is connected to the first valve member for providing a selected fluid to a press, the selected fluid being one of either the first fluid or the second fluid. A drain tube is provided for extracting the selected fluid from the press. A second valve member is connected to the drain tube for guiding flow therethrough. A first return line and a second return line are connected to the second valve member. A conduit is positioned between the supply tube and the drain tube for enabling draining of the supply tube and the drain tube between selection of the first fluid and the second fluid.

The present application claims the benefit of U.S. Provisional Patent Application Ser. No. 60/222,704 filed Aug. 2, 2000, and which is incorporated by reference herein.

### BACKGROUND

1. Field of the Invention

The present invention relates to a printing coating system for the printing industry and, more particularly, to a coating material supply system and a method for supplying print coatings.

2. Description of Related Art

In the printing industry, and in particular, when printing or coating web, sheet or discrete products (“printed product”), a is coating material is used and a drum is partially submersed in a tray filled with the coating material. The coating drum rotates in the coating material and the coating material is deposited from a surface of the coating drum to the printed product passing thereover in the press (printing press). Subsystems are designed and incorporated to perform such functions as level detectors for coating material as well as a plurality of other aspects of the coating operation. A more complete discussion of such systems and, particularly, a printed product coating material supply apparatus and method are set forth and shown in co-pending U.S. patent application Ser. No. 09/422,845 which is incorporated herein by reference.

A problem in prior art coating systems is that when a type of coating substance was to be changed to another type of coating substance in a printing or coating system, the entire printing/coating system had to be stopped, partially dismantled, manually cleaned, and then restarted again. Precious time was utilized during the cleaning process that delayed printing or coating the product.

For example, an aqueous coating may be used in a particular printing/coating press or certain printed product production runs. Other printed product production runs may require a liquid ultra-violet light-sensitive coating (“UV coating”). Conventional UV coatings are not compatible with aqueous coatings. When the UV coating material contacts with aqueous coating material, a gummy substance may form, which has an adverse effect on the printing/coating press. Thus, after using an aqueous coating in a press, the aqueous coating residue remaining in the coating system's circulation lines must be removed from the circulation lines prior to introduction of a UV coating material. The aqueous coating residue is generally removed by dismantling the supply lines and flushing the supply lines manually with appropriate chemicals or compressed air. After the aqueous coating residue is manually removed from the system's circulation lines, the system is reassembled. UV coating can now be introduced to the system and be utilized in the printing/coating press without creation of a gummy residue. Furthermore, metallic inks and other modern inks and coating substances have reaction and compatibility issues when used in the same press. In essence, the incompatibility of various inks and coating substances create significant maintenance and efficiency issues in the printing industry.

To better clarify the maintenance issues, all supply lines as well as reservoirs, nozzles, valves, etc. which are in contact with coating materials must be purged and cleaned manually of all coating residue before a new coating material is introduced thereinto. If reservoirs and/or circulation lines are difficult to access and/or clean, then the cost of the maintenance is significantly increased. Further, the downtime for the maintenance can itself become a prohibitive factor with regard to a particular coating system design and/or the feasibility for the use of a particular coating type in a multiple coating application system. It would be an advantage to provide a single coating system that allows for a plurality of coating substances to discretely flow therethrough. The discrete flow would minimize the amount of manual maintenance and cleaning between coating changes and minimize the costs and time required to change a coating material within the system. It would likewise to be an advantage to provide such a system that is highly reliable and energy efficient.

### SUMMARY OF INVENTION

The present invention relates to a printing supply system for a plurality of coating substances and a method for supplying the plurality of coating substances. In particular, the printing supply system includes a first supply line for supplying a first fluid and a second supply line for supplying a second fluid. A first valve member is connected to the first supply line and to the second supply line. A supply tube is provided connected to the first valve member for providing a selected fluid to a press, the selected fluid being one of either the first fluid or the second fluid.

A drain tube is provided for extracting the selected fluid from the press. A second valve member is connected to the drain tube. A first return line and a second return line are connected to the second valve member.

A conduit is provided between the supply tube and the drain tube, for enabling draining of the supply tube and the drain tube between selection of the first fluid and the second fluid.

In certain preferred embodiments, a programmable logic controller is provided to direct overall operation of the system. The connecting conduit may have a first conduit valve substantially near the supply tube and a second conduit valve substantially near the drain tube. Both first and second conduit valves are electrically connected to the programmable logic controller.

A pump and valve portion is provided in the system for moving fluids and/or gases therethrough. A cleaning fluid or water drum adapted to contain cleaning fluid or water is connected to the pump and valve portion. The pump and valve portion in combination with the water drum is adapted to circulate the water through the printing supply system for cleaning the system.

In operation, the first fluid is supplied to and from the press via the supply tube and the drain tube respectively, with the conduit valve or valves in a closed position. The first fluid supply is then stopped and drained from the press via the drain tube. The supply is next switched to a cleaning fluid. The conduit valve or valves are adjusted to an open position which allows fluid flow therethrough. The cleaning fluid is then supplied through the supply tube, the drain tube and the conduit.

After sufficient time for cleaning, the cleaning fluid supply is halted and drained from the supply tube, the drain tube and the conduit. Another switching step occurs from the cleaning fluid to the second fluid. The conduit valve or valves are then placed in a closed position to prevent fluid flow therethrough. Finally, the second fluid is supplied to and from the press via the supply tube and the drain tube.

### BRIEF DESCRIPTION OF THE DRAWINGS

Features, aspects, and advantages of the present invention will become better understood with regard to the following description, appended claims, and accompanying drawings where:

FIG. 1 is a diagrammatic schematic of an exemplary coating supply system for a plurality of coating substances in accordance with the principles of the present invention;

FIG. 2 is a perspective view of a supply drum with supply and return lines connected thereto and a fluid level sensor;

FIG. 3 is an enlarged cross-sectional view of the supply drum of FIG. 2; and

FIG. 4 is a diagrammatic schematic of an exemplary water supply and heating system for use with the coating supply system of FIG. 1.

### DETAILED DESCRIPTION OF THE PREFERRED EXEMPLARY EMBODIMENTS

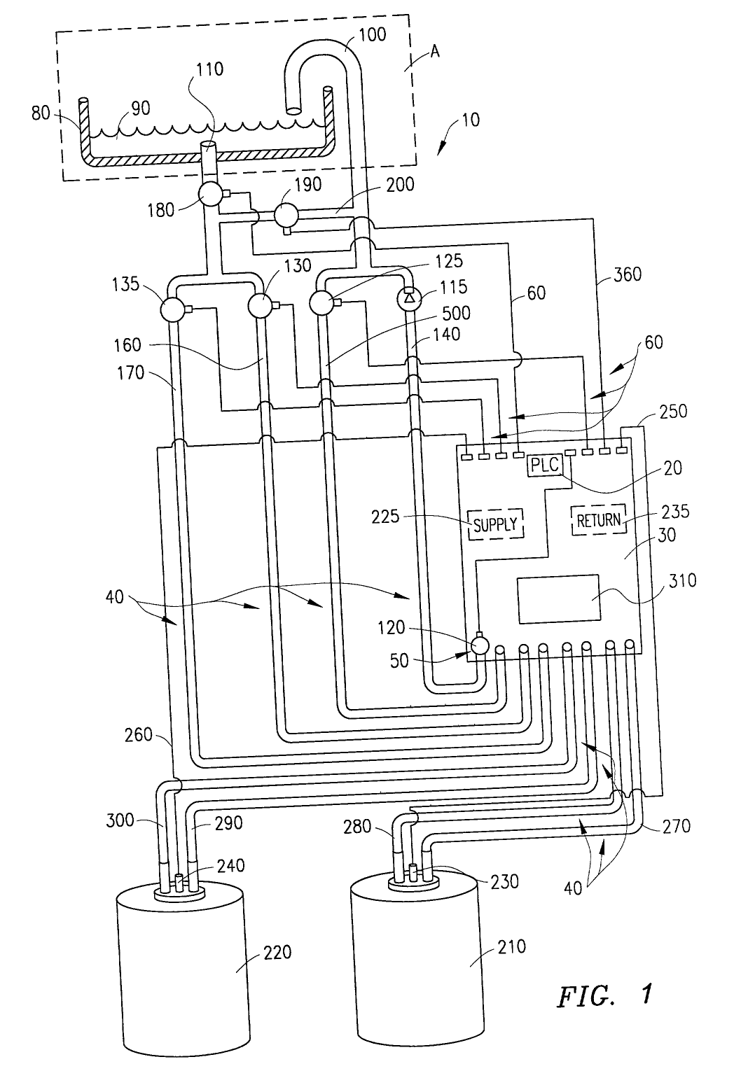

Referring first to FIG. 1, there is shown a diagrammatic schematic illustration of one embodiment of a print coating supply system 10 for different coating substances in accordance with the principles of the present invention. The supply system 10 includes a programmable logic controller 20 (“PLC”) within a cabinet 30 (“PLC cabinet”). It is to be understood throughout this application that the PLC cabinet 30 includes certain elements of the supply system 10, including but not limited to air pumps, actuators, actuator valves, fluid pumps, a programmable logic circuit such as a micro-controller, and the like. It is also to be understood that the printing press generally encompasses the section designed by reference “A”. The PLC cabinet 30 is connected to a plurality of supply lines and return lines 40 extending from a lower region 50 of the PLC cabinet 30. The PLC cabinet 30 is also connected to a plurality of electrical lines 60 extending from the PLC cabinet 30. The reference to the supply lines and return lines 40 and electrical lines 60 extending from upper and lower ends of the PLC cabinet 30 is only for purposes of discussion and clarity of the Figure. and in no way limits the present invention. Neither the size of the supply lines and return lines 40 nor the relative size of the PLC cabinet 30 are to be considered any more than diagrammatical schematic references.

Referring still to FIG. 1, the supply lines and return lines 40 are shown assembled beneath a coating tray 80. It is understood that the coating tray may be replaced by a chamber device or other device used to provide coating materials or ink to a printed product. The supply and return lines 40 are of a type typically used in a printing system. The coating tray 80 is supplied with a coating material 90 through a supply tube 100. The coating material 90 is drained from the coating tray 80 by a drain tube 110. The supply tube 100 is connected to a first coating supply line 140 and a second coating supply line 150. The first coating supply line 140 has an in-line check valve 115 oriented to allow flow of coating material 90 to supply tube 100 and prevent back-flow therefrom. The first coating supply line 140 also has a first solenoid supply valve 120 actuable to control flow of coating material 90 through the first supply line 140 into the supply tube 100. Second coating supply line 150 has a second solenoid supply valve 125 actuable to control flow of coating material 90 through the second supply line 150 into the supply tube 100. A first coating return line 160 has a first solenoid return valve 130 for controlling flow of coating material 90 from coating tray 80 to the return line 160. A second coating return line 170 has a second solenoid return valve 135 for controlling flow of coating material 90 from coating tray 80 to the return line 170. A solenoid main return valve 180 is provided in drain tube 110 to control flow from the coating tray 80 to the return lines 160, 170. A solenoid conduit valve 190 resides in a connecting conduit 200, which connects and extends between the supply tube 100 and drain tube 110. The operation of the conduit valve 190 in connection herewith is described in more detail below.

Referring still to FIG. 1, there is shown a first supply drum 210 containing a first coating and a second supply drum 220 containing a second coating. Supply drums 210, 220 are connected to the PLC cabinet 30 by the supply and return lines 40 extending from the supply drums 210, 220 to the lower region 50 of the PLC cabinet 30. The supply drums 210, 220 are preferably constructed or fitted with non-contact coating level sensors 230, 240. The non-contact coating level sensors 230, 240 are preferably secured in the upper regions of supply drums 210, 220, respectfully. The non-contact coating level sensors 230, 240 provide information to the PLC 20 within the PLC cabinet 30 by virtue of a first communication line 250 extending from sensor 230 and a second communication line 260 extending from the sensor 240. In this way the PLC 20 within the PLC cabinet 30 is able to determine the level of the respective coatings within the supply drums 210, 220 for actuation and control of the a supply pump system 225 and a return pump system 235, preferably located within the PLC cabinet 30) for introduction of the coating material 90 into the supply lines and return lines 40 discussed above. It is to be understood that the supply pump system 225 and return pump system 235 may have multiple connections to the various supply lines and return lines 40 as the application requires, and that one of ordinary skill in the art could easily devise such connections. For example, commonly owned and co-pending U.S. patent application Ser. No. 09/422,845 which is hereby incorporated by reference discloses an exemplary pumping system.

Each solenoid valve 120, 125, 130, 135, 180, and 190 is in communication with the PLC 20 of the PLC cabinet 30 via an electrical line 60. In this manner, the flow of coating fluid can be monitored and controlled by the PLC 20. For example, a first coating material from the first supply drum 210 can be supplied via a supply line 270 while the first supply valve 120 is open, the second supply valve 125 is closed, the first return valve 130 is open, and the second return valve 135 is closed. The first coating material may then return via the return line 280 to the first supply drum 210. Accordingly, when the first supply valve 120 is closed, the second supply valve 125 is open, the first return valve 130 is closed, and second return valve 135 is open, a second coating material from the second supply drum 220 can be supplied in the same manner by a supply line 290 and returned to the second supply drum 220 by a return line 300.

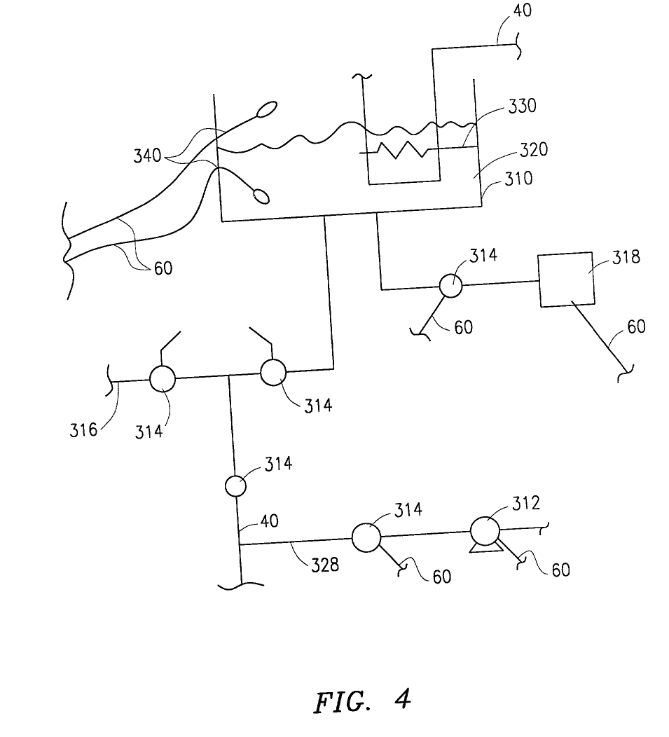

Referring now to FIGS. 1 and 4 in combination, also situated inside the PLC cabinet 30 is a cleaning fluid or water drum 310 containing cleaning fluid or water 320. The water 320 within the water drum 310 is maintained at an elevated temperature during operation of the supply system 10 via a heating element 330. Level sensors 340 are provided in the water drum 310 and are in electrical contact with the PLC 20 via electrical lines 60 for determination of the amount of water in the water drum 310. The water can be circulated from the PLC cabinet 30 to the coating tray 80 in the same manner as the coating material 90. A water source 318 having a source pump (not specifically shown) electrically connected to the PLC 20 via an electrical line 60 is provided for supplying water 320 to the water drum 310 via a water source line 324. A water valve 314 is connected in-line with the water source line 324 and has an electrical line 60 connected to the PLC 20 for regulating water flow. A water system supply line 326 is connected to the water drum 310 for supplying water 320 to the system 10 via the supply and return lines 40. A plurality of water valves 314 connected to the PLC 20 via electrical lines 60 are connected in-line to the water system supply line 326 for regulating water flow. A manual drain 316 is provided along the water system supply line 326 to allow a user to manually drain the water 320 from the water drum 310. In an optional configuration, a spray bar supply line 328 having a water pump 312 and a water valve 314 is provided for supplying water 320 to a spray bar 322. The water valve 314 and water pump 312 are both connected to the PLC 20 via electrical lines 60. A more complete discussion of the flow of the coating material and 90 and water 320 is described hereunder.

Referring back to FIG. 1, the conduit valve 190 is positioned adjacent to the drain tube 110 and supply tube 100 for cleaning the coating circulation and supply system 10 prior to changing to a different coating material. The conduit valve 190 is connected to the PLC 20 via respective communication wires 360.

Upon completion of running a first coating material (such as an aqueous based fluid) within the coating tray 80 through the supply system 10, a supply pump system 225 is turned off while a return pump system 235 continues to pump fluid out of the coating tray 80 via the drain tube 110 and return line 160 or 170. A residue from the coating material 90 may remain in the supply tube 100, coating tray 80 and drain tube 110. The residue may be manually cleaned from the inside surfaces of the coating tray 80 after the first coating is drained through the drain tube 110.

Excess coating material 90 in the form of droplets or residue remaining inside the supply tube 100 must be removed. A low pressure vacuum (preferably created by the return pump within the PLC cabinet 30) originating from the PLC cabinet 30 is utilized to draw air or water 320 (from the water drum 310) through the connecting conduit 200 between the drain tube 110 and supply tube 100.

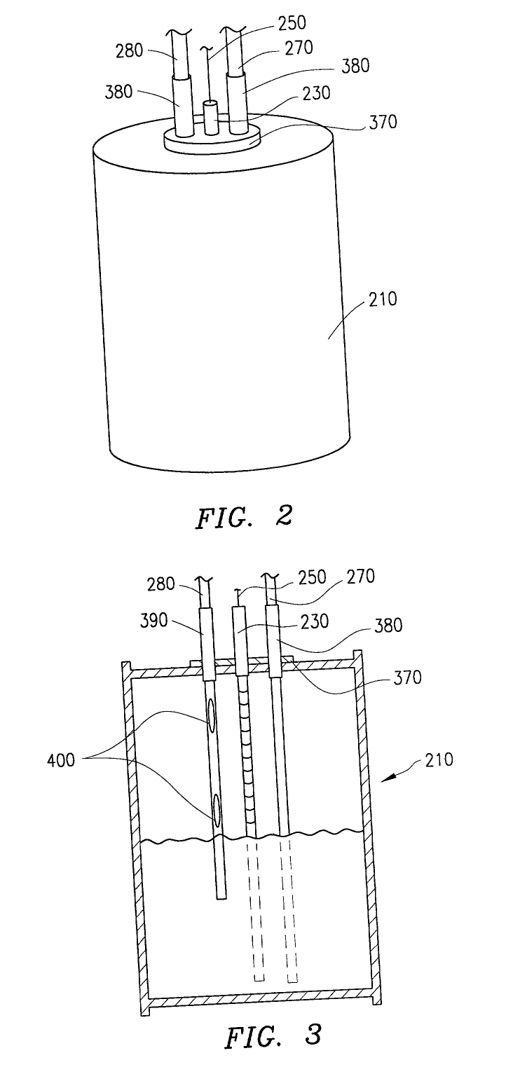

Referring now to FIG. 2, there is shown a prospective view of a coating material container such as the first supply drum 210 with a non-contact coating level sensor 230 disposed on top thereof. Supply lines 270 and return lines 280 are shown connected to the first supply drum 210 via a mounting bung 370 to provide access to the coating material contained therein. The supply line 270 and return line 280 may be inserted into the first supply drum 210 and mounting bung 370 by the use of collars 380 or other tubing connectors. It is conventional in the print industry to store coating material in a drum style container. In many circumstances, the drum style container is used as the source of coating material for a printing or coating system. In some printing and coating systems, it is advantageous to circulate the flow of coating out of the drum, through the system and back to the drum during the operation of an exemplary printing coating system. It is for this reason that the level of coating within a supply drum must be carefully maintained in order to prevent an overflow of coating material or the sucking of air from an empty drum during the printing operation.

Referring now to FIG. 3, there is shown a cross-section of the first supply drum 210 to illustrate the non-contact nature of the first non-contact coating level sensor 230, and an exemplary return line 390 construction. During operation of the print coating supply system 10, it is common for air to accumulate and integrate with the coating material 90 as it flows to and from the first supply drum 210. To alleviate build-up of foam and other undesirable properties in the coating material due to the presence of the air, two or more slots 400 are provided along the exemplary return line 390 in the first supply drum 210 to dissipate and minimize the effects of any such air that may be collected in the exemplary return line 390 and in the first supply drum 210 during operation.

During initial, transient and steady-state flow of the print coating supply system 10, fluid is removed from the first supply drum 210 and flows through the supply system 10 after a predetermined signal is sent from the PLC 20 in the PLC cabinet 30. A first non-contact coating level sensor 230 is in communication with the PLC 20 within the PLC cabinet 30 via an electrical line 60 extending from the first non-contact coating level sensor 230 and terminating at the PLC cabinet 30. Should the fluid level in the first supply drum 210 become too low during operation, the PLC 20 is alerted by the first non-contact coating level sensor 230. Thereafter, the PLC 20, which may be programmed accordingly, indicates the need for a new supply drum to be attached to the print coating supply system 10, or to indicate the need to increase return flow from the coating tray 80. A non-contact level sensor 230 may be provided on the coating tray 80 to aid the determination of whether the fluid contained therein reaches a high or low level. The non-contact level sensor 230 communicates this information to the PLC 20. In an exemplary case, coating fluid may be removed from the supply drum 210 faster than it is being returned from the coating tray 80. In this case, the non-contact level sensor 230 will indicate a defect in the flow operation and/or pumping operation to the PLC in the form of a low fluid level signal.

While several types of level sensors may be successfully substituted for a non-contact level sensor, the use of a non-contact level sensor is preferred. Coating materials tend to be viscous and leave an undesirable coating on contacted elements. Therefore, to prolong the life and reliability of sensor components, it is desirable to use a non-contact sensor. A preferred non-contact level sensor utilizes changes in atmospheric pressure to determine the fluid level in the first supply drum 210 or second supply drum 220. Other types of non-contact level sensors can include sensors that utilize ultrasonic sound, electromagnetic waves, or other acoustic waves to determine the fluid level.

It has been postulated that heating certain UV fluids enhances the properties of the UV fluid during operation of the print coating supply system 10. Therefore, in an alternate embodiment also shown in FIG. 4, supply lines 40 containing fluid from the UV drum are allowed to thermally communicate with the heated water within the water drum 310 prior to the UV fluid being directed toward the press. The resulting heat transfer from the water to the UV fluid should, therefore, enhance the properties of the UV fluid as is believed in the art.

Referring to FIGS. 1-4 in combination, during operation of the print coating supply system 10, a first fluid travels from the first supply drum 210 through the supply line 270 and into the PLC cabinet 30. The first fluid is next pumped out of the PLC cabinet 30 via supply pump system 225 through the first coating supply line 140 and to supply tube 100. The fluid may be heated in a manner described above by allowing the fluid to thermally communicate with the heated water drum 310 within the PLC cabinet 30. Next, the fluid is pumped into the supply tube 100 and into the coating tray 80. The unused coating material continues its circulation route through the drain tube 110 and subsequently through the first drain line 160. The fluid next travels back into the return line 280, finally completing one circulation cycle at the first supply drum 210.

To switch from a first fluid (e.g. aqueous based fluid) to a second fluid (e.g. UV fluid), the PLC 20 shuts off its supply pump system 225, which causes all supply flow to cease. The return pump system 235, remains on to remove remaining fluid in the coating tray 80, drain tube 110, second return valve 130, and return line 160. The PLC 20 then switches the supply line to the water drum 310, where heated water (from the water drum 310) is pumped from and allowed to circulate through the supply lines 140, 150, supply tube 100, coating tray 80, drain tube 110, and return lines 160, 170. After the water has finished circulating and has been returned to the PLC cabinet 30 and into the water drum 310 or sent to a waste container (not shown), return pump system 235 remains on and draws air into the drain tube 110 and the supply tube 100 after the opening and configuring of the second conduit valve 190. Once the air flow has been substantially removed and fluid droplets remaining have evaporated after the water/air flush, the return pump system 235 is turned off, the conduit valve 190 is closed to prevent incoming flow from the supply tube 100 and drain tube 110. The first supply valve 120 is closed, the second supply valve 125 opened, the first return valve 130 is closed, and second return valve 135 is opened to allow the second fluid to begin circulation from the second supply drum 220 via the supply pump system 225 with little risk of contamination from the first fluid.

It is understood that various pumping configurations can be provided within the PLC cabinet 30 that can accommodate the requirements of the present invention. One of ordinary skill in the art could easily create at least one pumping configuration that will accomplish the requirements of the present invention and as such, a specific pumping configuration is not specifically shown in the present Figures.

It is believed that the operation and construction of the present invention will be apparent from the foregoing description of the preferred exemplary embodiments. While the print coating supply system for a plurality of coating substances shown is described as being preferred, it will be obvious to a person of ordinary skill in the art that various changes and modifications made may be made therein without departing from the spirit and the scope of the invention.

What is claimed:

1. A fluid supply system for supplying a first fluid or a second fluid to a press, the fluid supply system comprising:
a first supply line plumbed to supply the first fluid to the press;
a first supply valve in said first supply line to control flow in the first supply line;
a second supply line plumbed to supply the second fluid to the press;
a second supply valve in said second supply line to control flow in the second supply line;
a first return line connected to drain fluid from the press;
a conduit in communication with said first and second supply lines and said first return line; and
a conduit valve in said conduit to control flow through the conduit, wherein opening the conduit valve enables fluid from the first or the second supply line through the conduit to by-pass the press.

2. The fluid supply system of claim 1, further comprising:
a programmable logic controller connected to actuate at least one of said first supply valve, second supply valve, and conduit valve to control fluid flow through the fluid supply system.

3. The fluid supply system of claim 2, further comprising:
a pump in communication with said programmable logic controller, said pump further being connected to at least one of said first supply line, said second supply line, said first return line and said second return line for selectively moving fluid therethrough.

4. The fluid supply system of claim 3, further comprising:
a first fluid supply line adapted to be connected to a first fluid supply source;
a first fluid return line adapted to be connected to said first fluid supply source;
a second fluid supply line adapted to be connected to a second fluid supply source; and
a second fluid return line adapted to be connected to said second fluid supply source.

5. The fluid supply system of claim 2, further comprising a first sensor means electrically connected to said programmable logic controller for detecting a fluid level in a first fluid supply source.

6. The fluid supply system of claim 2, further comprising second sensor means electrically connected to said programmable logic controller, for detecting a fluid level in said second fluid supply source.

7. The fluid supply system of claim 5, wherein said first sensor means is a non-contact level sensor.

8. The fluid supply system of claim 6, wherein said second sensor means is a non-contact level sensor.

9. The fluid supply system of claim 2, wherein said conduit valve is electrically connected to said programmable logic controller.

10. The fluid supply system of claim 3, further comprising:
a cleaning fluid supply source for containing cleaning fluid, said cleaning fluid supply source being connected to said pump, said cleaning fluid supply source in combination with said pump being adapted to circulate water in a predetermined manner through at least two of said first supply line, said second supply line, said first return line, said second return line, said supply tube, said drain tube, and said conduit.

11. The fluid supply system of claim 9, wherein cleaning fluid in said cleaning fluid supply source is maintained at a predetermined elevated temperature by a heating element.

12. The fluid supply system of claim 11, wherein said first supply line is thermally coupled to said cleaning fluid of said cleaning fluid supply source for selectively heating said first fluid.

13. The fluid supply system of claim 11, wherein said second supply line is thermally coupled to said cleaning fluid of said cleaning fluid supply source for selectively heating said second fluid.

14. The fluid supply system of claim 1, wherein said first fluid is aqueous fluid, and said second fluid is a fluid that is reactive to ultra-violet light.

15. The fluid supply system of claim 9, wherein when said conduit valve means is positioned to allow cleaning fluid from a cleaning fluid source to be pumped by a pump through said first supply line, said first valve member, said conduit, said supply tube and said drain tube to clean the fluid supply system.

16. A method of supplying fluid to a press, said method comprising the steps of:
supplying a first fluid to and from said press via a supply tube and a drain tube respectively, said supply tube and said drain tube being connected by a conduit means, said conduit means comprising a first valve in a closed position;
stopping the supply of said first fluid
draining said first fluid from said press via said drain tube;
switching from said first fluid to a cleaning fluid;
adjusting said conduit means to an open position which allows fluid flow therethrough;
supplying said cleaning fluid through said supply tube, said drain tube and said conduit means;
stopping the supply of said cleaning fluid;
draining said cleaning fluid from said supply tube, said drain tube and said conduit means;
switching from said cleaning fluid to a second fluid;
placing said first valve in a closed position to prevent fluid flow therethrough; and
supplying a second fluid to and from said press via said supply tube and said drain tube.

17. The method of claim 16, further comprising the step of stopping the supply of said second fluid.

18. The method of claim 17, further comprising the step of draining said second fluid from said press via said drain tube.

19. The method of claim 18, wherein said method is repeated after said step of draining said second fluid from said press.

20. The method of claim 18, further comprising the steps of:
switching from said second fluid to said cleaning fluid;
adjusting said conduit means to allow fluid flow therethrough;
supplying said cleaning fluid through said supply tube, said drain tube and said conduit means;
stopping the supply of said cleaning fluid; and
draining said cleaning fluid.

21. The method of claim 16, wherein said conduit means further comprises a second valve.

22. A fluid supply structure, comprising:
a container bung adapted to fit in a lid portion of a container;
a fluid supply line for supplying a fluid from said container to a printing system, attached and extending through said container bung into said container;
a fluid return line, for returning a fluid to said container from a printing system, attached to and having a portion extending through said container bung into said container; and
a sensor, positioned on said container bung adapted to measure a fluid level in said container.

23. The fluid supply structure of claim 22, wherein said fluid return line has a plurality of slots on the portion extended through said container bung for dissipating gases from said fluid line to aid the minimization of foaming of said fluid.
